(19) United States
(12) Patent Application Publication
(10) Pub. No.: US 2023/0082117 A1
(43) Pub. Date: Mar. 16, 2023

(54) ALLEVIATING EYE FATIGUE

(71) Applicant: Meta Platforms Technologies, LLC, Menlo Park, CA (US)

(72) Inventors: Dana Nicole Sasinowski, Seattle, WA (US); Kiran Mascarenhas, Bellevue, WA (US); Gabrielle Catherine Moskey, San Mateo, CA (US)

(21) Appl. No.: 17/941,910

(22) Filed: Sep. 9, 2022

Related U.S. Application Data
(60) Provisional application No. 63/244,127, filed on Sep. 14, 2021.

(51) Int. Cl. G06F 3/01; G06T 11/00

(52) U.S. Cl. CPC G06F 3/013; G06T 11/00; G06T 2200/24

(57) ABSTRACT

Methods, systems, and storage media for alleviating eye strain and/or fatigue occasioned by use of head mounted augmented and/or virtual reality equipment are disclosed. Exemplary implementation may: detect, at an eye fatigue sensor of a head mounted augmented and/or virtual device, that a user is experiencing eye strain and/or fatigue, and, responsive to the eye strain/fatigue detection, initiate at least one remedial action to alleviate the detected eye strain/fatigue.

### CROSS-REFERENCE TO RELATED APPLICATION

This present application claims the benefit of priority under 35 U.S.C. § 119(e) to U.S. Provisional Application No. 63/244,127, filed Sep. 14, 2021, the disclosure of which is hereby incorporated by reference in its entirety for all purposes.

### TECHNICAL FIELD

The present disclosure generally relates to head mounted virtual and/or augmented reality equipment. More particularly, the present disclosure relates to utilizing one or more features of head mounted virtual and/or augmented reality equipment to alleviate eye strain and/or fatigue occasioned by the use of such equipment.

### BACKGROUND

Over the past several decades, electronic devices have revolutionized people's lives in a multitude of ways. While many of these revolutionary electronic device uses offer what is generally viewed as benefits to a user's lifestyle, there also exist a number of largely inadvertent negative side effects. For instance, as many electronic devices include a visual component, for instance, a back-lighted screen of some kind, the increase in the number of different electronic devices has caused a resultant increase in the amount of time users spend viewing such screens. As more and more tasks capable of being engaged with by electronic devices increases, the amount of time users spend viewing screens continues to increase at a rapid pace. Further, as developments continue to progress in the use of equipment capable of generating augmented and/or virtual reality environments, such rapid increase is showing no signs of slowing down.

### BRIEF SUMMARY

The subject disclosure provides for systems and methods for determining that there is at least a substantial likelihood that a user of an electronic device having a visual component (e.g., a head mounted augmented and/or virtual reality device) is experiencing eye strain and/or fatigue (occasioned by the use of the electronic device) and, responsive to such determination, taking at least one remedial action to alleviate the eye strain/fatigue.

One aspect of the present disclosure relates to a method for alleviating eye strain and/or fatigue occasioned by use of head mounted augmented and/or virtual reality equipment. The method may include detecting, through an eye fatigue sensor of a head mounted expanded reality device, that a user is experiencing eye strain and/or fatigue. (As used herein, the term “expanded reality device” includes any and all virtual and/or augmented reality equipment.) The method may include, responsive to the eye strain/fatigue detection, initiating at least one remedial action to alleviate the detected eye strain/fatigue.

Another aspect of the present disclosure relates to a system configured for alleviating eye strain and/or fatigue occasioned by use of head mounted augmented and/or virtual reality equipment. The system may include one or more hardware processors configured by machine-readable instructions. The processor(s) may be configured to determine that a user has initiated use of an expanded reality device. The processor(s) may be configured to determine that a predetermined time period has elapsed since the user initiated use of the expanded reality device. The processor(s) may be configured to, responsive to determining that the predetermined time period has elapsed, initiate at least one remedial action to alleviate the eye strain/fatigue.

Yet another aspect of the present disclosure relates to a non-transient computer-readable storage medium having instructions embodied thereon, the instructions being executable by one or more processors to perform a method for alleviating eye strain and/or fatigue occasioned by use of an expanded reality device. The method may include detecting, through an eye fatigue sensor of a head mounted expanded reality device, that a user is experiencing eye strain and/or fatigue. The method may include: responsive to detecting the eye strain/fatigue, providing a notification informing the user that the eye strain and/or fatigue has been detected. The method may include initiating at least one remedial action to alleviate the detected eye strain/fatigue.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system configured for alleviating eye strain and/or fatigue occasioned by use of expanded reality equipment, in accordance with one or more implementations.

FIG. 2 illustrates an exemplary flow diagram for alleviating eye strain and/or fatigue occasioned by use of expanded reality equipment, according to certain aspects of the disclosure.

FIG. 3 illustrates an exemplary flow diagram for alleviating eye strain and/or fatigue occasioned by use of expanded reality equipment, according to certain aspects of the disclosure.

FIG. 4 illustrates an exemplary flow diagram for alleviating eye strain and/or fatigue occasioned by use of expanded reality equipment, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Over the past several decades, electronic devices have revolutionized people's lives in a multitude of ways. While many of these revolutionary electronic device offer what is generally viewed as benefits to a user's lifestyle, there also exists a number of largely inadvertent negative side effects. For instance, as many electronic devices include a visual component, for instance, a screen of some kind, the increase in the number of different electronic devices, and the corresponding increase in the number of uses for electronic devices, have caused a resultant increase in the amount of time users spend viewing such screens. As the number of tasks capable of being engaged with by electronic devices increases, the amount of time users spend viewing screens continues to increase at a rapid pace. Further, as developments continue to progress in the use of devices capable of generating augmented and/or virtual reality environments, such rapid increases are showing no signs of slowing down.

Viewing a screen that is generally in a relatively close field-of-view as it relates to a user's eyes utilizes different muscles in the eyes than viewing the world that physically exists around a user, as does viewing of augmented and/or virtual reality environments. As such, the increase in screen viewing time has resulted in an increase in the strain and/or fatigue experienced by a different set of eye muscles than humans had prior been used to. Such eye strain and/or fatigue has been shown, by researchers and users alike, to be detrimental to a user's eye health.

The subject disclosure provides for systems and methods for determining that there is at least a substantial likelihood that a user of expanded reality equipment (e.g., a head mounted augmented and/or virtual reality device) is experiencing eye strain and/or fatigue (occasioned by the use of the expanded reality equipment) and, responsive to such determination, taking at least one remedial action to alleviate the eye strain/fatigue.

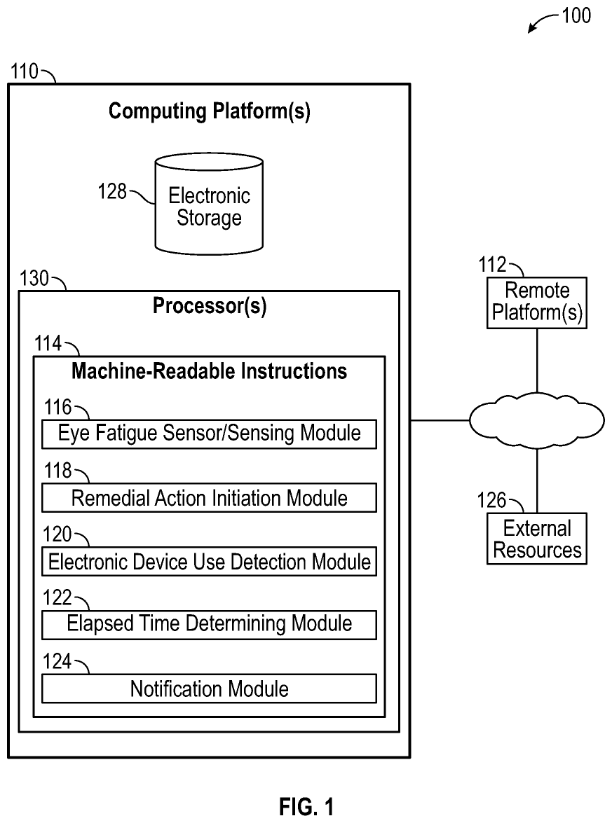

FIG. 1 illustrates a system 100 configured for alleviating eye strain and/or fatigue occasioned by use of expanded reality equipment (e.g., a head mounted augmented and/or virtual reality device), according to certain aspects of the disclosure. In some implementations, system 100 may include one or more computing platforms 110. Computing platform(s) 110 may be configured to communicate with one or more remote platforms 112 according to a client/server architecture, a peer-to-peer architecture, and/or other architectures. Remote platform(s) 112 may be configured to communicate with other remote platforms via computing platform(s) 110 and/or according to a client/server architecture, a peer-to-peer architecture, and/or other architectures. Users may access system 100 via remote platform(s) 112.

Computing platform(s) 110 may be configured by machine-readable instructions 114. Machine-readable instructions 114 may include one or more instruction modules. The instruction modules may include computer program modules. The instruction modules may include one or more of eye fatigue sensor/sensing module 116, remedial action initiation module 118, electronic device use detection module 120, elapsed time determining module 122, notification module 124 and/or other instruction modules.

Eye fatigue sensor/sensing module 116 may be configured to detect that a user is experiencing eye strain and/or fatigue. By way of non-limiting example, the eye fatigue sensor/sensing module 116 may be an eye strain sensor coupled with a pair of augmented reality glasses or goggles. By way of non-limiting example, the eye fatigue sensor/sensing module 116 may be an eye strain sensor coupled with a virtual reality headset. By way of non-limiting example, the eye fatigue sensor/sensing module 116 may be an eye strain sensor coupled with a front-facing camera of a laptop or desktop computing device. It will be understood by those having ordinary skill in the art that any of the above exemplary eye strain sensors, any combination thereof, and/or any other type of eye strain sensor that is in the environment of the user and capable of detecting eye strain and/or fatigue, is contemplated to be within the scope of aspects of the present disclosure.

Remedial action initiation module 118 may be configured to initiate at least one remedial action to alleviate eye strain/fatigue. In aspects, the remedial action initiation module 118 may be configured to initiate at least one remedial action to alleviate detected eye strain/fatigue responsive to the eye fatigue sensor/sensing module 116 detecting the eye strain and/or fatigue of the user. By way of non-limiting example, the at least one remedial action may be displaying a notification to the user that eye strain and/or fatigue has been detected. By way of non-limiting example, the at least one remedial action may be audibly communicating a notification to the user that eye strain and/or fatigue has been detected. By way of non-limiting example, the at least one remedial action may be displaying a suggestion that the user take a delineated action (e.g., look away from the electronic device, remove a pair of augmented reality glasses or goggles, turn off the “augmented” function of a pair of augmented reality glasses or goggles, turn off a virtual reality headset, turn of the “virtual” function of a virtual reality headset) to alleviate the detected eye strain/fatigue. By way of non-limiting example, the at least one remedial action may be audibly communicating a suggestion that the user take a delineated action to alleviate the detected eye strain/fatigue. By way of non-limiting example, the at least one remedial action may be suggesting that the user take one or more of the following actions: look away from the electronic device, remove a pair of augmented reality glasses or goggles, turn off the “augmented” function of a pair of augmented reality glasses or goggles, turn off a virtual reality headset, and/or turn off the “virtual” function of a virtual reality headset. By way of non-limiting example, the at least one remedial action may be automatically (i.e., without user action) altering at least one aspect of the lighting associated with a screen of the electronic device. By way of non-limiting example, the at least one remedial action may be displaying a suggestion that the user manually alter at least one aspect of the lighting associated with a screen of the electronic device. By way of non-limiting example, the at least one remedial action may be audibly communicating a suggestion that the user manually alter at least one aspect of the lighting associated with the screen of the electronic device. By way of non-limiting example, the at least one remedial action may be automatically (i.e., without user action) invoking a blue light filter on a screen of the electronic device. By way of non-limiting example, the at least one remedial action may be displaying a suggestion that the user manually invoke a blue light filter on a screen of the electronic device. By way of non-limiting example, the at least one remedial action may be audibly communicating a suggestion that the user manually invoke a blue light filter on a screen of the electronic device. By way of non-limiting example, the at least one remedial action may be automatically (i.e., without user action) invoking a dark mode on a user interface of the electronic device. By way of non-limiting example, the at least one remedial action may be displaying a suggestion that the user manually invoke a dark mode on a user interface of the electronic device. By way of non-limiting example, the at least one remedial action may be audibly communicating a suggestion that the user manually invoke a dark mode on a user interface of the electronic device. It will be understood by those having ordinary skill in the art that any of the above non-limiting remedial action example, any combination thereof, and any other actions that may alleviate eye strain and/or fatigue are contemplated to be within the scope of aspects of the present disclosure.

Electronic device use detection module 120 may be configured to detect that a user has initiated use of an electronic device. By way of non-limiting example, the electronic device may be a head mounted augmented and/or virtual reality device. By way of non-limiting example, the electronic device may be a laptop and/or desktop computing device. By way of non-limiting example, the electronic device may be a mobile computing device (e.g., a tablet computing device or a mobile telephone).

Elapsed time determining module 122 may be configured to determine that a predetermined time period has elapsed since a user initiated use of an electronic device such as a head mounted augmented and/or virtual reality device. In aspects, the elapsed time determining module 122 may be configured to determine that a predetermined time period has elapsed since the electronic device use detection module 120 detected that a user initiated use of a head mounted augmented and/or virtual reality device (or other electronic device). By way of non-limiting example, the predetermined time period may be twenty minutes. By way of non-limiting example, the predetermined time period may be configured such that there is at least a substantial likelihood that the user is experiencing eye strain and/or fatigue.

Notification module 124 may be configured to communicate various notifications to the user. In aspects, the notification module 124 may be configured to display one or more notifications to the user, the notifications configured for alleviating eye strain and/or fatigue of the user. By way of non-limiting example, such notifications may be displayed as remote (e.g., with adjusted size and or distance specifications) to promote eye health. In aspects, the notifications module 124 may be configured to audibly communicate one or more notifications to the user, the notifications configured for alleviating eye strain and/or fatigue. By way of non-limiting example, the notification module may be configured to communicate a notification informing the user the eye strain and/or fatigue has been detected. By way of non-limiting example, the notification module may be configured to communicate a notification suggesting one or more actions the user may take to alleviate eye strain and/or fatigue. By way of non-limiting example, the notification module may be configured to communicate a notification suggesting that the user look at something in their environment that is about twenty feet away for twenty seconds. By way of non-limiting example, the notification module 124 may be configured to communicate a notification that the user locate items in their immediate environment that are or include colors known to be gentle on the eyes (e.g., green) and look at those items for several seconds.

In aspects of the present disclosure, the system 100 may additionally include a computer interface (not shown) configured to provide signals that confirm whether eye strain and/or fatigue has occurred and/or is occurring.

In some implementations, computing platform(s) 110, remote platform(s) 112, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 110, remote platform(s) 112, and/or external resources 126 may be operatively linked via some other communication media.

A given remote platform 112 may include one or more processors configured to execute computer program modules. The computer program modules may be configured to enable an expert or user associated with the given remote platform 112 to interface with system 100 and/or external resources 126, and/or provide other functionality attributed herein to remote platform(s) 112. By way of non-limiting example, a given remote platform 112 and/or a given computing platform 110 may include one or more of a server, a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Computing platform(s) 110 may include electronic storage 128, one or more processors 130, and/or other components. Computing platform(s) 110 may include communication lines, or ports to enable the exchange of information with a network and/or other computing platforms. Illustration of computing platform(s) 110 in FIG. 1 is not intended to be limiting. Computing platform(s) 110 may include a plurality of hardware, software, and/or firmware components operating together to provide the functionality attributed herein to computing platform(s) 110. For example, computing platform(s) 110 may be implemented by a cloud of computing platforms operating together as computing platform(s) 110.

Electronic storage 128 may comprise non-transitory storage media that electronically stores information. The electronic storage media of electronic storage 128 may include one or both of system storage that is provided integrally (i.e., substantially non-removable) with computing platform(s) 110 and/or removable storage that is removably connectable to computing platform(s) 110 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from computing platform(s) 110, information received from remote platform(s) 112, and/or other information that enables computing platform(s) 110 to function as described herein.

Processor(s) 130 may be configured to provide information processing capabilities in computing platform(s) 110. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute modules 116, 118, 120, 122, and/or 124, and/or other modules. Processor(s) 130 may be configured to execute modules 116, 118, 120, 122, and/or 124, and/or other modules by software; hardware; firmware; some combination of software, hardware, and/or firmware; and/or other mechanisms for configuring processing capabilities on processor(s) 130. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 116, 118, 120, 122, and/or 124 are illustrated in FIG. 1 as being implemented within a single processing unit, in implementations in which processor(s) 130 includes multiple processing units, one or more of modules 116, 118, 120, 122, and/or 124 may be implemented remotely from the other modules. The description of the functionality provided by the different modules 116, 118, 120, 122, and/or 124 described above is for illustrative purposes, and is not intended to be limiting, as any of modules 116, 118, 120, 122, and/or 124 may provide more or less functionality than is described. For example, one or more of modules 116, 118, 120, 122, and/or 124 may be eliminated, and some or all of its functionality may be provided by other ones of modules 116, 118, 120, 122, and/or 124. As another example, processor(s) 130 may be configured to execute one or more additional modules that may perform some or all of the functionality attributed below to one of modules 116, 118, 120, 122, and/or 124.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

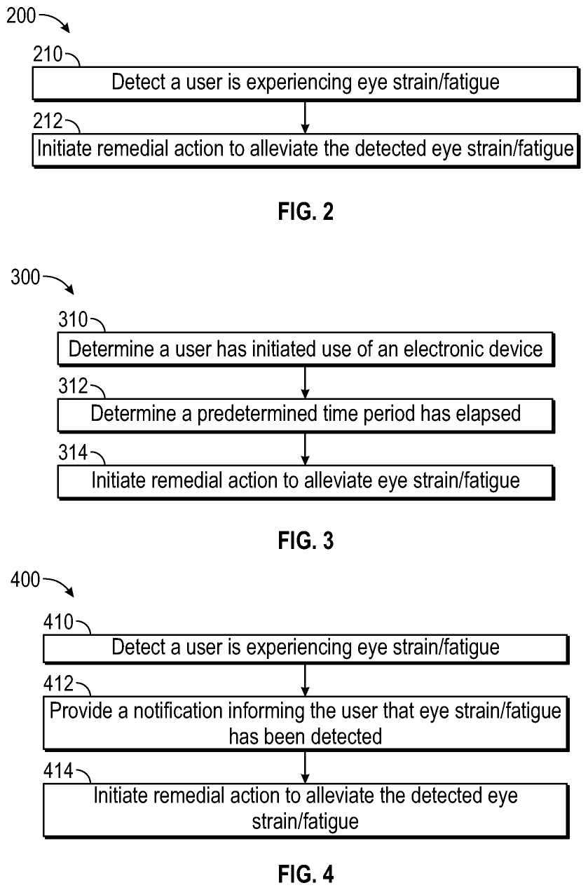

FIG. 2 illustrates an example flow diagram (e.g., process 200) for alleviating eye strain and/or fatigue occasioned by use of a head mounted augmented and/or virtual reality device, according to certain aspects of the disclosure. For explanatory purposes, the exemplary process 200 is described herein with reference to FIG. 1. Further for explanatory purposes, the steps of the exemplary process 200 are described herein as occurring in serial, or linearly. However, multiple instances of the exemplary process 200 may occur in parallel.

At step 210, the process 200 may include detecting, through an eye fatigue sensor of a head mounted augmented and/or virtual reality device (for instance, through the eye fatigue sensor/sensing module 116 of the system 100 of FIG. 1), that a user is experiencing eye strain and/or fatigue.

At step 212 the process 200 may include, responsive to the eye strain/fatigue detection, initiating at least one remedial action to alleviate the detected eye strain/fatigue (e.g., through remedial action initiation module 118 of the system 100 of FIG. 1).

FIG. 3 illustrates an exemplary flow diagram (e.g., process 300) for alleviating eye strain and/or fatigue occasioned by use of a head mounted augmented and/or virtual reality device, according to certain aspects of the disclosure. For explanatory purposes, the exemplary process 300 is described herein with reference to FIG. 1. Further for explanatory purposes, the steps of the exemplary process 300 are described herein as occurring in serial, or linearly. However, multiple instances of the exemplary process 300 may occur in parallel.

At step 310, the process may include determining (e.g., through the electronic device use detection module 120 of the system 100 of FIG. 1) that a user has initiated use of a head mounted augmented and/or virtual reality device.

At step 312, the process 300 may include determining (e.g., through the elapsed time determining module 122 of the system 100 of FIG. 1) that a predetermined time period has elapsed since the user initiated use of the head mounted augmented and/or virtual reality device.

At step 314, the process 300 may include, responsive to determining that the predetermined time period has elapsed, initiating at least one remedial action to alleviate the eye strain/fatigue (e.g., through the remedial action initiation module 118 of the system 100 of FIG. 1).

FIG. 4 illustrates an exemplary flow diagram (e.g., process 400) for alleviating eye strain and/or fatigue occasioned by use of a head mounted augmented and/or virtual reality device, according to certain aspects of the disclosure. For explanatory purposes, the exemplary process 400 is described herein with reference to FIG. 1. Further for explanatory purposes, the steps of the exemplary process 400 are described herein as occurring in serial, or linearly. However, multiple instances of the exemplary process 400 may occur in parallel.

At step 410, the process 400 may include detecting, through an eye fatigue sensor of a head mounted augmented and/or virtual reality device (e.g., through the eye fatigue sensor/sensing module 116 of the system 100 of FIG. 1), that a user is experiencing eye strain and/or fatigue.

At step 412, the process 400 may include, responsive to detecting the eye strain/fatigue, providing a notification (e.g., through the notification module 124 of the system 100 of FIG. 1) informing the user that the eye strain and/or fatigue has been detected.

At step 414, the process 400 may include initiating at least one remedial action to alleviate the detected eye strain/fatigue (e.g., through the remedial action initiation module 118 of the system 100 of FIG. 1).

The term “machine-readable storage medium” or “computer readable medium” as used herein refers to any medium or media that participates in providing instructions to a processor for execution. Such a medium may take many forms, including, but not limited to, non-volatile media, volatile media, and transmission media. Non-volatile media include, for example, optical or magnetic disks. Volatile media include dynamic memory. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the present disclosure. For example, while operations are depicted in the drawings in a particular order, this should not be understood as requiring that such operations be performed in the particular order shown or in sequential order, or that all illustrated operations be performed to achieve desirable results. The actions recited in the present disclosure can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the present disclosure.

What is claimed is:

1. A computer-implemented method for alleviating eye strain or eye fatigue occasioned by use of a head mounted augmented and/or virtual reality device, the method comprising:
detecting, through an eye fatigue sensor of the head mounted augmented and/or virtual reality device, that a user is experiencing eye strain detection or eye fatigue detection; and
in response to the eye strain detection or fatigue detection, initiating at least one remedial action to alleviate the detected eye strain detection or eye fatigue detection.

2. The method of claim 1, wherein the at least one remedial action comprises altering at least one aspect of lighting associated with a display screen of the head mounted augmented and/or virtual reality device.

3. The method of claim 1, wherein the at least one remedial action comprises invoking a blue light filter on a display screen of the head mounted augmented and/or virtual reality device.

4. The method of claim 1, wherein the at least one remedial action may invoke a dark mode on a user interface of the head mounted augmented and/or virtual reality device.

5. The method of claim 1, wherein the at least one remedial action comprises turning off the head mounted augmented and/or virtual reality device.

6. The method of claim 1, wherein the at least one remedial action comprises turning off the “virtual” and/or “augmented” function of the head mounted augmented and/or virtual reality device.

7. The method of claim 1, wherein the at least one remedial action is completed automatically.

8. A system configured for alleviating eye strain or eye fatigue occasioned by use of a head mounted augmented and/or virtual reality device comprising:
one or more hardware processors configured by machine-readable instructions to:
determine that a user has initiated use of a head mounted augmented and/or virtual reality device; and
in response to eye strain detection or fatigue detection, initiate at least one remedial action to alleviate the detected eye strain or eye fatigue.

9. The system of claim 8, wherein the one or more processors are further configured to determine that a predetermined time period has elapsed since the user initiated use of the head mounted augmented and/or virtual reality device.

10. The system of claim 8, wherein the one or more processors are further configured to initiate at least one remedial action to alleviate the eye strain or eye fatigue in response to determining that a predetermined time period has elapsed.

11. The system of claim 8, wherein the at least one remedial action may invoke a dark mode on a user interface of the head mounted augmented and/or virtual reality device.

12. The system of claim 8, wherein the at least one remedial action comprises turning off the head mounted augmented and/or virtual reality device.

13. The system of claim 8, wherein the at least one remedial action comprises turning off the “virtual” and/or “augmented” function of the head mounted augmented and/or virtual reality device.

14. A non-transient computer-readable storage medium having instructions embodied thereon, the instructions being executable by one or more processors to perform a method for alleviating eye strain or eye fatigue occasioned by use of a head mounted augmented and/or virtual reality device, the method comprising:
detecting, through an eye fatigue sensor of a head mounted augmented and/or virtual reality device, that a user is experiencing eye strain or eye fatigue;
responsive to detecting the eye strain or eye fatigue, providing a notification informing the user that the eye strain or eye fatigue has been detected; and
initiating at least one remedial action to alleviate the detected eye strain or eye fatigue.

15. The non-transient computer-readable storage medium of claim 14, wherein the at least one remedial action comprises altering at least one aspect of lighting associated with a display screen of the head mounted augmented and/or virtual reality device.

16. The non-transient computer-readable storage medium of claim 14,wherein the at least one remedial action comprises invoking a blue light filter on a display screen of the head mounted augmented and/or virtual reality device.

17. The non-transient computer-readable storage medium of claim 14, wherein the at least one remedial action may invoke a dark mode on a user interface of the head mounted augmented and/or virtual reality device.

18. The non-transient computer-readable storage medium of claim 14, wherein the at least one remedial action comprises turning off the head mounted augmented and/or virtual reality device.

19. The non-transient computer-readable storage medium of claim 14, wherein the at least one remedial action comprises turning off the “virtual” and/or “augmented” function of the head mounted augmented and/or virtual reality device.

20. The non-transient computer-readable storage medium of claim 14, wherein the at least one remedial action is completed automatically.
